(19) United States
(12) Patent Application Publication
(10) Pub. No.: US 2010/0052613 A1
(43) Pub. Date: Mar. 4, 2010

(54) CHARGER WITH AUDIO PLAY-THROUGH

(75) Inventors: David Leung, San Mateo, CA (US); Yasuhiro Yamamoto, Los Angeles, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster Cable Products, Inc., Brisbane, CA (US)

(21) Appl. No.: 12/201,446

(22) Filed: Aug. 29, 2008

(51) Int. Cl. H02J 7/00

(52) U.S. Cl. 320/114

(57) ABSTRACT

A battery charger having an integral cable management means is adapted to receive power from a vehicle electrical system and provide power to a portable personal electronic device, for recharging the portable personal electronic device battery while allowing the audio and/or video output of the device to simultaneously be provided for listening or viewing by the user.

### TECHNICAL FIELD

The present invention is related to portable personal electronic devices. More specifically it is related to recharging of the batteries for portable personal electronic devices. Even more specifically it is related to a portable personal audio and visual electronic device battery recharging apparatus which allows for playback operation while charging the portable personal electronic device.

### BACKGROUND OF THE INVENTION

Portable electronic devices are necessarily powered by batteries. The variety of available battery types and designs, coupled with the variety of portable electronic devices, results in the need to design battery chargers uniquely associated with a specific electronic device. In the case of audio playback portable devices, there is a need to provide a battery recharger that includes the additional capability to operate the audio device for the user's listening through an external entertainment system while the audio device battery is undergoing recharge. Modern entertainment systems frequently include an auxiliary audio input socket for connection with an external source of signal data information such as artist, title, etc. With the “iTrip Autopilot”® portable electronic device charger by Griffin Technology, for example, the user is provided with an additional cable to connect the electronic device with an external entertainment system, separately from the battery recharging circuitry, for connection with the entertainment system auxiliary audio input socket. This, however, means that the user must store the additional cable when the charger is not in use, creating the possibility that the charger and additional cable may become separated and not be available when needed. Thus, what is needed is a battery charger that provides for both charging and operating the audio device simultaneously, without the possibility of a misplaced cable.

Accordingly, in a vehicle such as a car or a boat for example, a user may wish to use a portable electronic device in conjunction with the vehicle's entertainment system and simultaneously charge the portable electronic device battery. What is therefore needed is a connection between the portable electronic device and the entertainment system. Preferably, both recharging the device battery and playback from the device is made possible by a single apparatus.

### DISCLOSURE OF THE INVENTION

Accordingly, the present invention is a battery charger adapted to receive power from a vehicle electrical system, typically by insertion in a cigarette lighter receptacle or the like, and to provide power to a portable personal electronic device (PPED), such as an iPod®, for recharging the PPED battery, while simultaneously allowing the audio output of the PPED to be provided for listening by the user. A signal/power cable connected to the PPED docking port, is disposed near a cable management spool which is retractable into the charger housing for storage therein. A second cable is provided for connection with an external entertainment system for playback of signal data such as artist, title, etc. The spool upon which the cables are wound is captive by the charger body and is sufficiently removable to allow a user to manually wind the cables upon the spool for storage. The spool-body relationship is similar to the spool-cover used for adhesive tape. The housing and power receiver portions of the apparatus are adjustably angularly moveable relative to each other in planar orientation. The audio output is routed to a separate vehicle-mounted entertainment system via a wireless FM link.

The present invention is described in terms of use with an iPod®, but it is to be understood that reference to a PPED in the present description includes audio (such as an iPod® or iPhone®) and video devices such as digital video disk (DVD) playback devices.

An additional capability of the present invention is the provision of a control, as appropriate, of the PPED audio function, such as play/pause, track up/down, playlist up/down, and the like. The control is preferably hardwired within the present invention but may alternatively be a wireless remote device.

A further capability of the present invention is the provision of safety functions such as circuit breakers, either manually or automatically resettable, and ground loop isolation electrical circuitry. Additional safety functions may include current and/or voltage limiting.

### BRIEF DESCRIPTION OF THE DRAWING

For a better understanding of the present invention, reference is made to the below referenced accompanying Drawing. Reference numbers refer to the same or equivalent parts of the present invention throughout the several figures of the Drawing.

FIG. 1 is a perspective view of an exemplary embodiment of the present invention.

FIG. 2 is an exemplary schematic diagram of the embodiment of FIG. 1.

FIG. 3 is an exemplary schematic diagram of a cigarette lighter adapter suitable for use with the embodiment of FIG. 1.

FIG. 4 is an exemplary schematic diagram of a remote control suitable for use with the embodiment of FIG. 1.

### BEST MODES FOR CARRYING OUT THE INVENTION

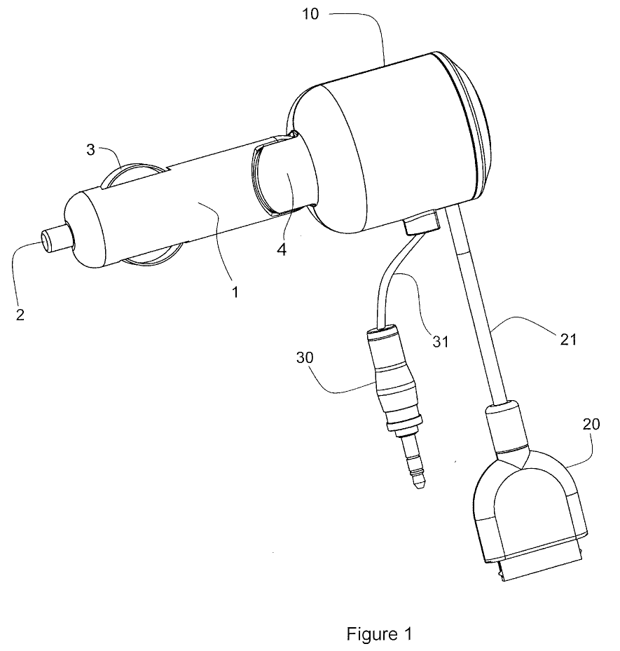

Referring now to FIG. 1, an exemplary embodiment of the present invention is shown. Battery charger 100 comprises adapter 1, configured to be inserted into a vehicle cigarette lighter receptacle, or a similar vehicle utility power outlet. Power contact 2 makes contact with the vehicle power system and ground contact 3 makes contact with the vehicle ground. Adapter 1 is adjustably angularly oriented to body 10 by joint 4 which provides planar movement over a range of 90 degrees.

Charger body 10 houses the necessary electrical circuitry for converting the vehicle power, typically 12 VDC, into the proper voltage and current for the PPED. If the PPED is an iPod® for example, the output voltage is 5 volts, limited to approximately 1000 mw. Body 10 further houses a cable management spool (not shown) to store auxiliary cable 31 that connects a jack 30, typically a 3.5 mm mini-jack, to the electronic circuitry within body 10. Jack 30 mates with an auxiliary audio input receptacle (not shown) in the vehicle entertainment system for providing for PPED playback through the entertainment system while the PPED battery is being recharged. In this preferred exemplary example, cable 31 is retractably stored within body 10 by being manually wound upon the spool (not shown). Cable 31 may be any convenient length, typically up to six feet, and preferably approximately three feet.

PPED jack 20 is frequently unique to a particular PPED. In this exemplary example, it is an iPod® male jack, suitable for mating to an iPOD® dock connection. PPED jack 20 is connected to the electronic circuitry within body 10 by signal/power cable 21. Cable 21 may be any convenient length, typically up to six feet, and preferably approximately three feet.

In the preferred exemplary embodiment, cable 21 is retractably stored within body 10 by also being manually wound upon the cable management spool (not shown). The relationship between body 10 and the spool is similar to the cover and spool used for adhesive tape. As a result, any length of either or both cables may be unwound from the spool at the user's choice.

Body 10 contains electronic protection circuitry, as well as charging circuitry. The preferred embodiment includes safety functions such as automatically resettable circuit breakers and ground loop isolation electrical circuitry. Additional safety functions may include current and/or voltage limiting.

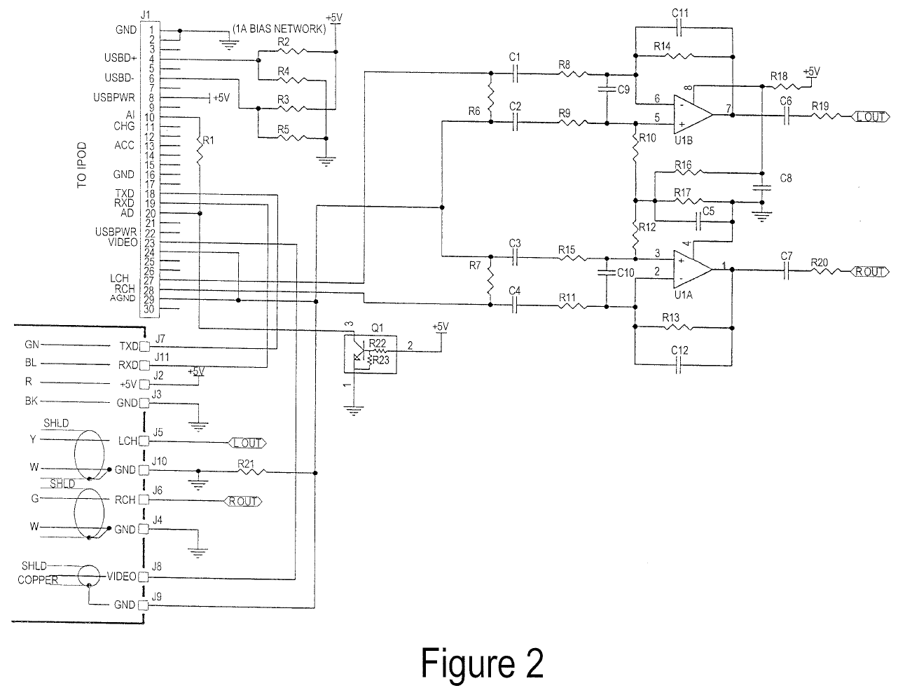

FIG. 2 is an electronic schematic of the exemplary embodiment of the present invention. Table 1 identifies the values of the components shown in FIG. 2.

TABLE 1

| ELEMENT IDENTIFIER | VALUE OR COMPONENT |
|---|---|
| R1 | 1 M, 1% |
| R2 | 75K, 1% |
| R3 | 43.2K, 1% |
| R4, R5 | 49.9K, 1% |
| R6, R7, R21 | 1K |
| R8, R9, R10, R11, R12, R13, R14, R15 | 100K, 1% |
| R16, R17 | 200K |
| R18 | 10 |
| R19, R20 | 100 |
| R22 | 47K |
| R23 | 22K |
| C1, C2, C3, C4 | 0.1 MFD |
| C5, C6, C7, C8 | 10 MFD |
| C9, C10, C11, C12 | 33 PF |
| J1 | iPOD ® MALE |
| Q1 | DTC144WET1G |
| U1A, U1B | LMV822MM |

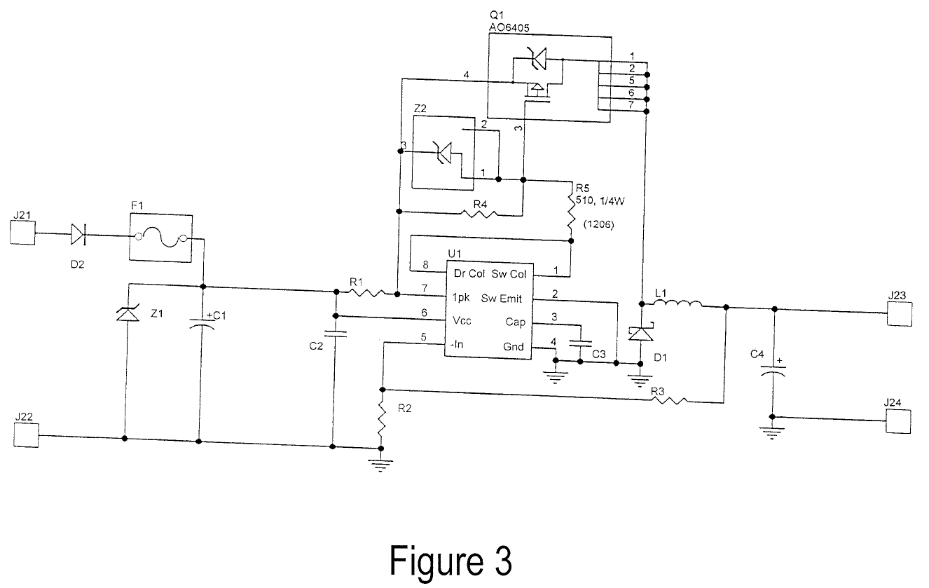

FIG. 3 is an electronic schematic of the cigarette lighter adapter 1 portion of the exemplary embodiment of the present invention. Junction J21 corresponds to power contact 2 of FIG. 1 and J22 corresponds to ground contact 3. Junction J23 provides 5 v, 1000 ma power to the circuitry of FIG. 3. Table 2 identifies the values of the components shown in FIG. 3.

TABLE 2

| ELEMENT | |
|---|---|
| IDENTIFIER | VALUE OR COMPONENT |
| R1 | 0.24, ¼ W |
| R2 | 1.21K, 1% |
| R3 | 3.65K, 1% |
| R4 | 680 |
| R5 | 510, ¼ W (1206) |
| C1 | 47 MFD/35 |
| C2 | 0.01 MFD |
| C3 | 470 PF |
| C4 | 330 MFD/6.3 LOW ESR |
| D1 | 1N5819 |
| D2 | S2D(SMB) |
| F1 | 1 A (603) |
| L1 | 330 UH |
| Q1 | A06405 |
| U1 | SP34063 (SO-8) |
| Z1 | 1N4752A/33 V |
| Z2 | BZX84C6V8 |

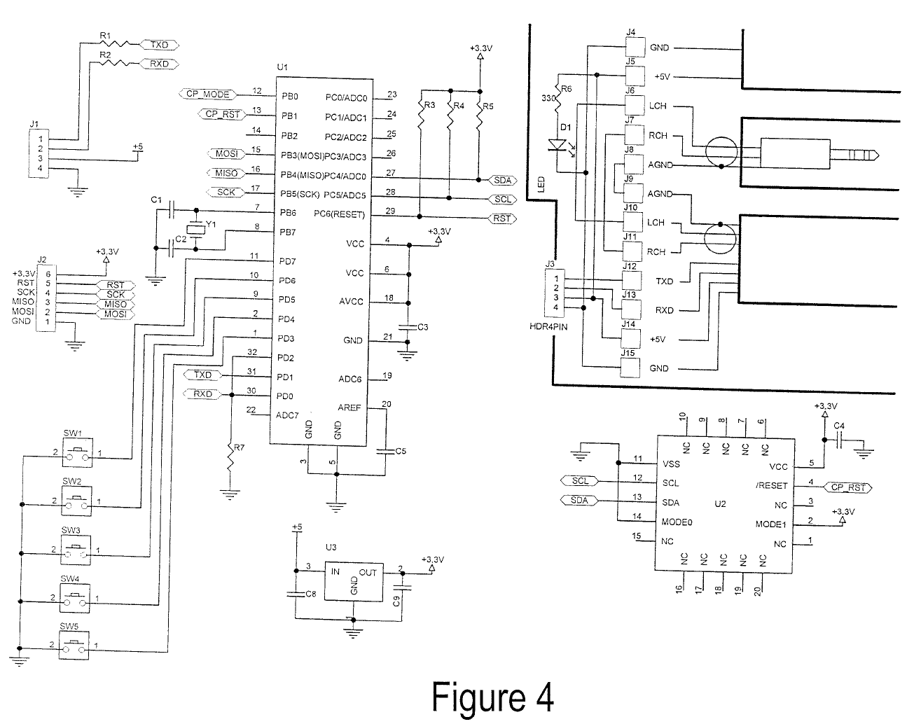

The exemplary preferred embodiment of the present invention includes a control (not shown) designed to operate the PPED, in this example an iPod®. The external appearance of such a control is not necessary for understanding the present invention. FIG. 4 is an electronic schematic of a suitable control for use with the exemplary embodiment of the present invention. Table 3 identifies the values of the components shown in FIG. 4. Switches SW1-SW5 are LO PRO TACT SW.

TABLE 3

| ELEMENT | |
|---|---|
| IDENTIFIER | VALUE OR COMPONENT |
| R1 | 100 |
| R2, R3, R4, R5 | 10K |
| R6 | 330 |
| R7 | 100K |
| C1, C2 | N.U. |
| C3, C4, C5 | 0.1 UFD |
| C8 | 0.33 MFD |
| C9 | 10 MFD |
| D1 | LED SMT 0603 BLU |
| J1, J3 | HDR 4 PIN |
| J2 | 6P 1 MM EDGE |
| J4, J8, J9, J15 | GND |
| J5, J14 | +5 V |
| J6, J10 | LCH |
| J7, J11 | RCH |
| J12 | TXD |
| J13 | RXD |
| U1 | ATMEGA48 |
| U2 | Apple Authentication |
| | Co-Processor Class 5 |
| | Rev B |
| U3 | AME 8800 |
| Y1 | 32.768 KHZ |
| SW1 | REW |
| SW2 | PLAY |
| SW3 | FWD |
| SW4 | PPL |
| SW5 | NPL |

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.”

All structural and functional equivalents to the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. 112, sixth paragraph, unless the element is expressly recited using the phrase “means for.”

### INDUSTRIAL APPLICABILITY

The present invention applies industrially to battery chargers for portable personal electronic devices (PPED), configured with connectors and captive cables for connection between the charger and the PPED. The invention uniquely combines readily available electrical and mechanical components to allow a skilled practitioner to assemble and use the invention.

What is claimed:

1. A battery charger having a housing and connectable to a vehicle electrical power system, for charging a portable personal electronic device having a battery recharging port, comprising:
an adapter connectable to the vehicle electrical power system;
a signal/power cable and connector connectable to the battery recharging port; and
a cable management apparatus, having at least one cable spool retractable into the housing.

2. (canceled)

3. The battery charger of claim 1 further having a control for controlling the portable personal electronic device.

4. The battery charger of claim 3 wherein the control provides at least track up, track down, next play list, and previous play list functions.

5. The battery charger of claim 1 further including at least one safety device.

6. The battery charger of claim 5 wherein the at least one safety device is selected from the group of safety devices consisting of circuit breakers, ground loop isolators, current limiters, and voltage limiters.

7. The battery charger of claim 1 wherein the portable personal electronic device is an audio device.

8. The battery charger of claim 1 wherein the portable personal electronic device is a video device.

9. The battery charger of claim 1 wherein the adapter is adjustably angularly disposed relative to the housing.

10. The battery charger of claim 1 further having a second cable and connector for connecting the charger with an auxiliary audio input jack of an external entertainment system, the second cable coupled with the cable management apparatus for receiving the second cable in a wound configuration.

11. A battery charger having a housing and connectable to a vehicle electrical power system, for charging a portable personal electronic device having a battery recharging port, comprising:
an adapter connectable to the vehicle electrical power system, wherein the adapter is adjustably angularly disposed relative to the housing;
a signal/power cable and connector connectable to the battery recharging port;
a second cable and connector connectable with an auxiliary audio input jack of an external entertainment system; and
a cable management apparatus, retractable into the housing, wherein the cable management apparatus includes at least one cable spool for receiving the second cable in wound configuration for storing the cable in said housing.

12. The battery charger of claim 11 further having a control for controlling the portable personal electronic device.

13. The battery charger of claim 12 wherein the control provides at least track up, track down, next play list, and previous play list functions.

14. The battery charger of claim 12 further including at least one safety device.

15. The battery charger of claim 14 wherein the at least one safety device is selected from the group of safety devices consisting of circuit breakers, ground loop isolators, current limiters, and voltage limiters.

16. The battery charger of claim 15 wherein the portable personal electronic device is an audio device.

17. The battery charger of claim 15 wherein the portable personal electronic device is a video device.

18. A battery charger having a housing and connectable to a vehicle electrical power system, for charging a portable personal electronic device having a battery recharging port, comprising:
an adapter connectable to the vehicle electrical power system, wherein the adapter is adjustably angularly disposed relative to the housing;
a signal/power cable and connector connectable to the battery recharging port;
a second cable and connector connectable with an auxiliary audio input jack of an external entertainment system;
a cable management apparatus, retractable into the housing and having at least one cable spool for receiving the signal/power and second cables in wound configuration; and
at least one safety device selected from the group of safety devices consisting of circuit breakers, ground loop isolators, current limiters, and voltage limiters.

19. The battery charger of claim 18 wherein the portable personal electronic device is an audio device.

20. The battery charger of claim 18 wherein the portable personal electronic device is a video device.

21. The battery charger of claim 10 wherein the cable spool is adapted for receiving the signal/power cable in wound configuration.
